(19) United States
(12) Patent Application Publication
(10) Pub. No.: US 2006/0206434 A1
(43) Pub. Date: Sep. 14, 2006

(54) Accurately linking alarm system financing to equity and contractual flows

(76) Inventors: Dave Hill, Hayward, CA (US); Tim LeBlanc, Corona, CA (US)

Correspondence Address: GEORGE S. COLE, ESQ., 495 SEAPORT COURT, SUITE 101, REDWOOD CITY, CA, 94063, US

(21) Appl. No.: 11/069,291

(22) Filed: Feb. 28, 2005

(51) Int. Cl. G06Q 99/00; G08B 29/00; G08B 1/00

(52) U.S. Cl. 705/64; 705/75; 705/76; 340/506; 340/531

(57) ABSTRACT

Selling alarm systems and services previously depended upon the dealers being both the source, of the financing considered necessary for and used to obtain the hardware, and also to sustain linked monitoring and service contracts. Difficulties associated with turnover of both customers and dealers, and the separation between ownership of the alarm hardware and real property where it was installed, created additional transaction and frictional costs. By reversing the credit focus from the alarm dealer to the customer, coordinating ownership of the hardware with the ownership of the protected property, making explicit, rather than concealed, the true charge for associated services, and centralizing these tasks, this method enables both higher-volume and more accurately profitable sales of alarm systems and services.

### BACKGROUND OF THE INVENTION

1.A. Field of the Invention

This invention is a method for enabling more efficient, transparent, and tax-policy coordinated sales of systems (hardware) and services (monitoring and maintenance) for security alarms.

1.B. Description of the Related Art

What distinguishes a security alarm system from a stand-alone alarm, is the ability of the security alarm system to report an event and not just sound a local alarm. Accordingly, anyone buying a security alarm system is actually buying 3 inter-related parts. The first part is that security alarm system's hardware (the ‘hardware’). This hardware will comprise one or more sensors, each of which is connected to a reporting unit (the alarm). The second part is a monitoring contract, that is, a contract with an outside entity to whom the hardware reports incidents. This contract may also include reporting on non-performance of the hardware, remote testing of the hardware, or even forwarding the report to an appropriate respondent (i.e. if the hardware reports a break-in, the report is forwarded to the police; if the hardware reports a sharp upward rise in temperature, the report is forwarded to the fire department). The third part is a servicing contract, a contract to respond to problems with and provide maintenance for the hardware. Security alarm systems that are not actively monitored are not covered by this invention (as such generally, after a limited number of false alarms, are disregarded and ineffective, as anyone who has walked past a beeping car alarm can attest). For this reason, the phrases ‘security alarm system’ and ‘alarm system’ hereafter are equivalent, unless specifically identified otherwise, with ‘monitored security alarm system’.

Under the prior art, the majority of purchasers of security alarm systems (hereinafter ‘purchasers’) were told that they would get their hardware “for free”; but they were required to sign up for a unified monitoring and servicing contract that required both a definite minimum term (typically three years) and regular (identical, usually monthly) payments to the security alarm system dealer (hereinafter ‘dealer’). The purchaser would see the dealer as the entity who sold, delivered, installed, monitored, and serviced the alarm system.

In reality, however, the typical dealer contracted with a monitoring company to monitor the installed alarm system, then used the monthly payment from the purchaser to buy that service. The dealer also typically split off and sold the servicing contract to a financial services firm, to both defray the dealer's cost for the hardware and boost his cash flow. Built into the purchaser's monthly payment, therefore, was both a monitoring company's servicing charge and a hidden financing charge for the hardware. The financing charge was also entirely divorced from a real property owner's capacity to tie financing of capital improvements to his property's equity, to decreased insurance costs, or to any other overall financial or tax incentives the law provides for real property owners. Because the financing charge was both hidden and depended entirely upon the financial standing of the dealer, and because the financial services firm typically filed a state UCC lien for each alarm system to secure its interest against default by either the purchaser or dealer, the financing charge tended to be high as it had to cover these frictional costs.

Furthermore, the financial services firm generally insisted on maintaining control over the servicing, even though it lacked the technical expertise and personnel to respond to typical servicing and maintenance problems. The financial services firm also generally lacked the responsiveness to purchasers' immediate needs. A further problem is that a high failure rate of dealers pushed up their credit costs, to the purchasers' disadvantage. Consequently the finance companies have been constraining and driving dealers' business potential, even though the finance companies have been neither tracking nor responding to the market needs and wishes of those who wanted to buy or sell alarm systems.

Most alarm system sales, under the prior art, did not turn profitable until the beginning of the fourth year, when the initial contract's monthly fees had finally paid off the financing charge for the hardware (which was still legally owned by the dealer). This approach has one glaring problem: the reality of a high turn-over rate during the first three years has ended up pitting the purchaser against the dealer with a built-in, significant systemic legal cost. This has often tied unhappy parties together and badly drained profits from contracts which continued past the third year.

There were three exceptions to this general state. First was theoretically possible—but very difficult—for an individual to purchase, on his own, security alarm hardware, then find an dealer to service it, and then find a monitoring company to monitor it. Second, it was also possible for a purchaser to pay cash at the start for the hardware, removing the need for financing. Because of the higher frictional costs or reduced profits from such individual actions, few or even at times none of those in the business (dealers, monitoring companies, or finance companies) were interested in agreeing to such action by purchasers, effectively prohibiting these practices.

Secondly, for a short time a limited attempt was made to offer individual financing to individual purchasers; but the effort still left ownership of the hardware with the dealer and not the purchaser, and neither considered nor used that purchaser's credit. It also separated the monitoring and servicing and sales profitability from the actual cash flow to the dealer, did not incorporate sufficient intercommunication to overcome the diversity of interests, and did not remove the associated frictional costs.

### SUMMARY OF THE INVENTION

The present invention turns the current approach completely around. Instead of requiring that the alarm system dealer be both the focus, and source, of the financing which is used to obtain the alarm system hardware and to make the monitoring and servicing contracts sustainable—even if only minimally profitable—during the first three years, a central monitoring service provider (‘CMS’) serves as the organizing agent. The CMS can arrange large-volume financing from one or more financial sources, perform a creditworthiness check for each individual alarm system purchaser, and then offer a financing opportunity for that alarm system purchaser and dealer at the start of any sale. A dealer who is negotiating with a would-be purchaser can offer a known, fixed, maximum cost at signing, which is divided between the purchaser, the dealer, and the CMS. The purchaser's credit is used to acquire the hardware, which thereafter belongs to the purchaser (thereby adding to his realty's equity, and making the hardware transferable to a new dwelling). The purchaser's monthly fee is lower as he is paying only the financing charge for the hardware and a minimal monitoring and servicing charge for the first term, which is typically three years. The dealer has greatly lowered frictional costs, need not tie up his capital in alarm system hardware, does not have to include the costs of UCC lien registration into the financing charge (as the standard legal processes for credit defaults are available since the ownership follows the hardware to the purchaser), does not need to run a monitoring service as well as a sales operation, and does not have to seek out or check his customers' financing. The CMS shares the greatly lowered frictional costs, gains efficiencies of scale and thereby increases its market attractiveness to multiple alarm system dealers, and provides improved efficiency and protection through unique per-dealer, per-purchaser, and even per-contract identifiers, thereby lowering operating costs even further. Both the dealer and the CMS gain far more stable monthly revenues without requiring financing ties and their associated frictional costs, and together they can, after the hardware is paid off, when the purchaser seeks to renew his servicing agreement, offer lower monthly payments for the monitoring service renewal, which greatly increases the most profitable period for both dealer and CMS.

### BRIEF DESCRIPTION OF THE DRAWINGS

FIG. 1 shows the process flow of the prior art approach.

FIG. 2 shows the general flow of the method disclosed in this application.

FIG. 3 shows the detail of the interaction between each customer, alarm system dealer, and the central monitoring service provider in the preferred embodiment.

### DETAILED DESCRIPTION OF THE DRAWINGS

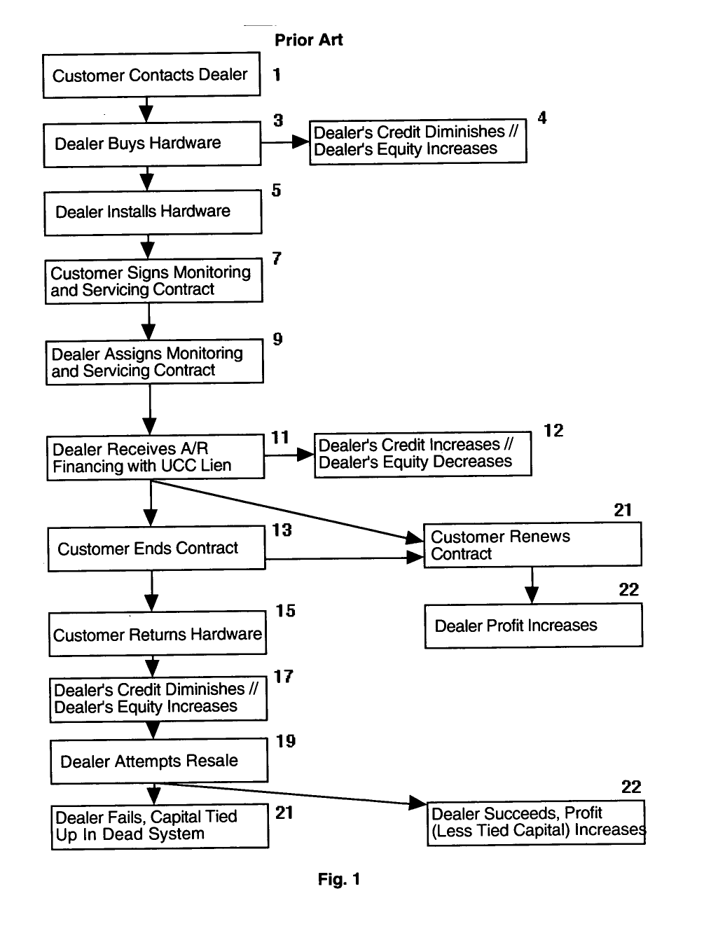

FIG. 1 shows the process flow of the prior art approach. When a prospective purchaser (labeled ‘customer’) contacts the alarm system dealer (1) the two parties work out the probable transaction. Then the dealer buys the hardware (3). This causes the dealer's equity to increase as he adds the new hardware to his physical assets, but his credit to diminish as he reduces his cash or, more typically, increases his indebtedness to leverage his cash (4). The dealer then installs the hardware in the customer's realty (5), while the customer signs a monitoring and servicing contract (7). To increase specialization and improve his cash flow, the dealer assigns the monitoring and service contract (9) (typically as a condition of the financing and purchase arrangement for the hardware), while the vendor of the hardware provides accounts receivable (‘A/R’) financing and enters a UCC property lien (11). This step both increases the transaction cost and overhead for all parties, and increases the dealer's credit but decreases his equity (12). After a period of time (usually 3 years), the customer either will end the monitoring and service contract (13), or renew it (21). If the customer ends the contract, he returns the hardware (15). (Optionally, not shown, the customer may buy it, but at a reduced price reflecting 3 years' depreciation and wear.) This increases the dealer's equity by the reduced value of the hardware, but diminishes his credit by removing A/R financing for an ongoing contract (17). The dealer then attempts to resell the hardware (19), which if unsuccessful leaves the dealer with part of his capital tied up in a ‘dead’ system (21), but even if successful, still leaves the dealer with a reduced profit representing the depreciation-plus-wear difference in the purchase and sales prices (22).

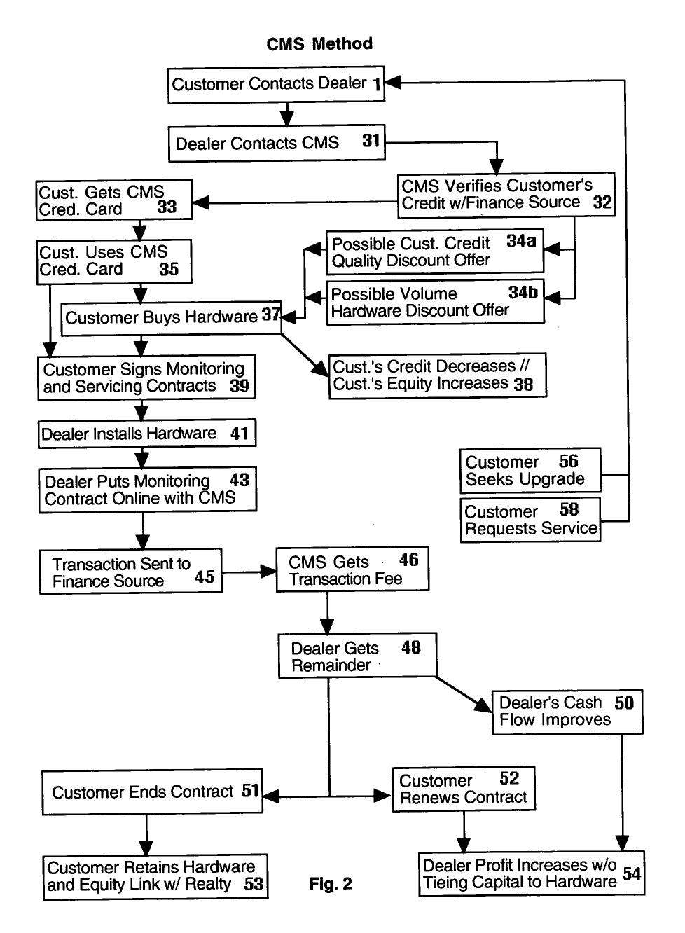

FIG. 2 shows the general flow of the method described in this application. When a prospective customer contacts the alarm system dealer (1) the two parties work out the probable transaction. The dealer then contacts the central monitoring service provider (‘CMS’) (31), who performs a credit check on the customer's credit (32). Depending on the results of the credit check, the CMS may offer the hardware at a credit quality discount (34a). Separately, and possibly additionally, if the dealer has a strong ‘book of business’ with the CMS, the CMS may offer the hardware at a volume discount (34b). The CMS discloses to the dealer the customer's credit score, which keeps the dealer from having to run a separate credit check, avoiding multiple close-in-time credit checks which can reduce a customer's credit score, as well as reporting on whether the customer passes the credit check (not shown). If the customer passes the credit check, the CMS offers the customer a private-label credit card (33), which can then be used to purchase the hardware (35). After learning the (possibly reduced) price from the dealer, the customer (and not the dealer) buys the hardware (37). This will decrease the customer's credit, but increase the customer's equity (38). The customer also signs separate but linked installation, monitoring, and servicing contracts with the dealer (39). The dealer then installs the hardware (41), after which he puts the monitoring contract on-line with the CMS (43). The CMS sends the transaction to the financial source (45), which delivers the funds to the CMS who subtracts the transaction and associated fees which explicitly covers the handling and financing costs for both the dealer and the CMS (46), and then the CMS delivers the remainder of the funds to the alarm system dealer (48). This improves the dealer's cash flow (50) and the dealer's profit without tying the profit or his capital to the installed hardware (54). As the customer's credit is used and the customer owns the property, the credit risk is linked to the realty and thus avoids the need for UCC Lien papers (not present, and so not shown), while providing the customer with the tax advantages from an increased realty equity (not shown). If, during the contract period, the customer seeks a hardware upgrade (56), or additional monitoring service (58), the customer contacts the dealer (1) and the dealer contacts the CMS (31), to repeat steps 32-50 (excepting, of course, a repeat issue of an existing private label credit card (33)). At the end of any term of the monitoring contract, the customer may simply end the contract with the dealer (51), yet the customer retains the hardware with the realty (53). Alternatively, if the customer renews the contract (52), then the dealer's profit again increases without tying further capital to the hardware (54).

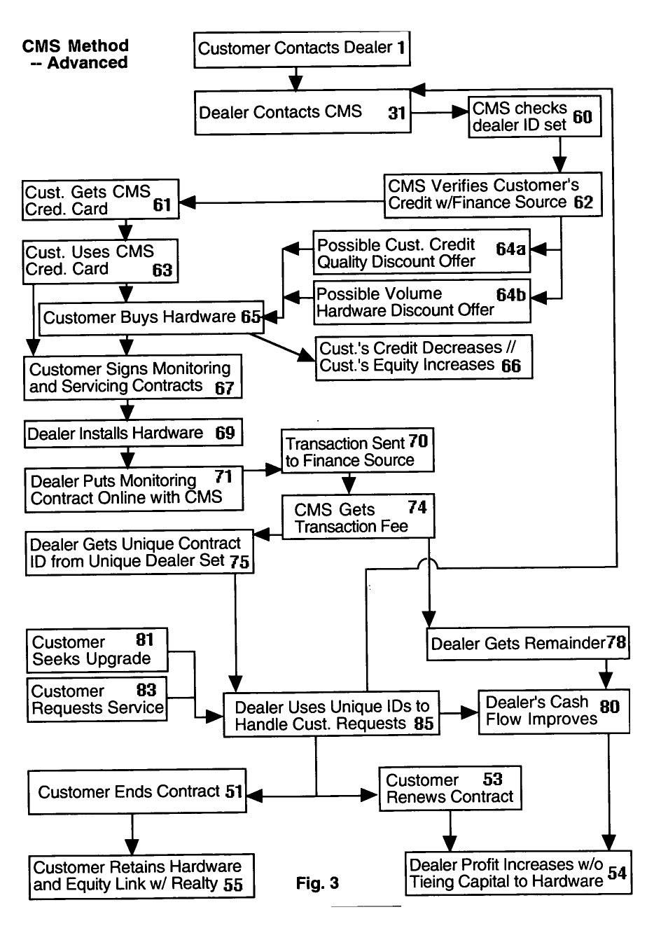

FIG. 3 shows the process flow of the more advanced method described in the preferred embodiment of the invention. When a customer contacts an alarm system dealer (1) the two parties work out the probable transaction. The dealer then contacts the central monitoring service provider (‘CMS’) (31). The CMS checks the dealer's ID set (60), and if the contact lacks a pre-authorized ID either ensures that one is provided (for a new dealer, by issuing one; for an unauthorized employee, by requiring authorization from the dealer). In repeat business, this check ensures that only transactions using that dealer's unique ID will go forward, protecting both the dealer and the customer. Having validated the dealer's ID, the CMS performs a credit check on the customer's credit (62). Depending on the results of the credit check, the CMS may offer the hardware at a credit quality discount (64a). Separately, and possibly additionally, if the dealer has a strong ‘book of business’ with the CMS, the CMS may offer the hardware at a volume discount (64b). The CMS also discloses to the dealer the customer's credit score, which keeps the dealer from having to run a separate credit check, avoiding multiple close-in-time credit checks which can reduce a customer's credit score (not shown). If the customer passes the credit check, the CMS offers the customer a private-label credit card (61), which can then be used to purchase the alarm system hardware (63). After learning the (possibly reduced) transaction price from the alarm system dealer, the customer (and not the dealer) buys the hardware (65). This will decrease the customer's credit, but increase the customer's equity (66). The customer also signs separate but linked installation, monitoring, and servicing contracts with the dealer (67). The dealer then installs the hardware (69), after which he puts the monitoring contract on-line with the CMS (71). The CMS sends the transaction to the financial source (70), which delivers the funds to the CMS who subtracts the transaction and associated fees which explicitly covers the handling and financing costs for both the dealer and the CMS (74), and then the CMS delivers the remainder of the funds to the dealer (78). This improves the dealer's cash flow (80) and the dealer's profit without tying the profit or his capital to the installed hardware (54). The dealer is assigned a unique contract ID for that particular customer's monitoring contract, the ID coming from the set of such provided solely to that dealer (75). If a customer request comes to the dealer (85), the dealer uses the unique ID combination (his plus that customer's contract's unique IDs) to handle that customer request; thereby increasing the privacy protection while enabling lower-down personnel to access and manage the particular problem or opportunity for that account, thereby improving the dealer's cash flow (80), further freeing the dealer's profits from the installed hardware or specific contract management (54). If, during the contract period, the customer seeks a monitoring or hardware upgrade (81), or requests service (83), the dealer uses the unique ID combination to handle the customer request (85) when the dealer contacts the CMS (31) to repeat steps 60-75 (excepting, of course, a repeat issue of an existing private label credit card (61)). At the end of any term of the monitoring contract, the customer may simply end the contract with the dealer (51), yet the customer retains the hardware with the realty (55). Alternatively, if the customer renews the contract (53), then the dealer's profit again increases without tying further capital to the hardware (54).

### DETAILED DESCRIPTION

This method is used by a central monitoring service provider (CMS) to provide financing for residential and commercial security alarm system customers, and for a much larger number of such security alarm system customers, for and through a number of security alarm dealers. By linking the ownership of the hardware to the person owning the protected property, stronger ties, and ones more closely linked with societal tax and other incentives are created. By linking the hardware's financing to the purchaser and the owner of the protected property, eliminating or reducing the additional expenses of separated ownership (specifically, the costs for lien filings, for multiple and separate credit checks, and for both purchase and accounts receivable financing efforts), and making evident rather than concealing the true costs of financing, improved efficiency and gains from economies of scale are made feasible. By also letting the dealer, CMS, and financial source specialize yet interact, rather than forcing them to perform multiple roles, further operational efficiencies are made feasible, lowering the cost and improving the profitability for all parties.

The details of the method are explained above in the detailed description for FIGS. 2 and 3. Yet what is not shown (because it is no longer there) is almost as important as what is shown, for these reflect many of the advantages of the invention. In FIG. 1, the existing method of doing business is shown. Typically, as a requirement of the hardware purchase financing, the entity providing the dealer with the money to purchase the hardware requires both the monitoring and the servicing contracts to be assigned. This separates the party responsible for monitoring and maintaining the hardware from the dealer (the entity the customer is most familiar with), separates the person most familiar with the hardware (the actual goods that the customer can examine) likewise, and imposes a significantly more expensive extra step into the process, thereby greatly reducing its efficiency and increasing its cost. Furthermore, because financing companies typically know very little about either alarm system monitoring or alarm system hardware maintenance, the separation between monitoring and hardware maintenance exacerbates greatly the potential for hardware/software conflicts to create trouble for the customer. Next, the separation of the monitoring contract from the dealer reduces the dealer's recurring monitoring revenue—which greatly reduces the dealer's incentive to sell and keep more contracts. It focuses the dealer on maximizing the profit in the initial sale and installation, despite the fact that the greater amount of long-term profit comes from renewal and retention of existing accounts, or the extension and expansion of additional services (sometimes called “cross-marketing”) to existing accounts. Finally, the prior art approach constrained the ability of the dealer, CMS, and financing source to specialize in their aspect of the overall process, which limits the efficiency each can gain through economies of scale and familiarity with their particular tasks.

In contrast to FIG. 1, in FIG. 2 there is no mention of the dealer assigning the servicing contract. The dealer can either retain it, and be responsible for maintaining the hardware himself (which keeps the knowledge of weaknesses and strengths closest to the sales point, building added value knowledge and real world expertise), or assign it separately from the monitoring contract, allowing the dealer to use competitive forces to provide more cost-effective and realizable service for the dealer's customers. Also not shown is any step for the hardware vendor instituting or recording a UCC Lien, which adds to the cost of the hardware. Because neither the dealer nor the central monitoring system are undertaking the financing risk, they do not need to build into the original transaction the additional ‘risk price’ should the customer default. Because the owner of the hardware is likewise the owner of the property to which the hardware is attached, the finance provider for the transaction can build in a lower price of pursuing default as there is no separation between the customer for the hardware and the person on whose property the hardware is installed.

Finally, the prior art provided no mechanism that met the deepest need of the purchaser of the alarm system—which was for security. That need extends to security from actions (or omissions) of the dealer, CMS, and financial source. By providing each dealer with a unique dealer ID, a set of unique authorized-employee IDs, and a set of unique contract IDs, the CMS enables secure and traceable interactions concerning any particular and unique combination of dealer, dealer's employee, purchaser, and contract. This inhibits and renders more difficult any ‘social engineering’ approach to breaching a purchaser's security alarm system that otherwise might work through the associated parties engaged in the process from installation through monitoring, servicing, upgrading, financing, or renewal.

Best Mode

In the preferred mode, central monitoring service provider and a security alarm dealer will enter into a tiered relationship with an alarm system purchaser. At the bottom tier (dealing with the alarm system hardware), the central monitoring service provider evaluates and uses each particular alarm system purchaser's credit to fund the purchase and installation of the alarm system hardware by the alarm system purchaser (not by either the security alarm dealer or the central monitoring service provider). This means that the purchase and ownership confers the tax deduction and the related equity increase to the alarm system purchaser, and removes the credit risk (and cost of both credit and default) from both the security alarm dealer and the central monitoring service provider.

Both the security alarm dealer and central monitoring service provider learn a particular alarm system purchaser's credit score without triggering separate inquiries and potentially lowering that alarm system purchaser's credit score. This enables that security alarm dealer to focus on those potential customers having the credit scores that have proven to be most profitable to that security alarm dealer. The central monitoring service provider, having established a volume-driven funding link with a financial source (such as a merchant bank or other, like, credit provider), issues to the alarm system purchaser a private-label credit card, which can be and is used to purchase the alarm system hardware. If the alarm system purchaser wishes to finance his purchase of the alarm system hardware through the means provided by the central monitoring service provider, he is offered a three year payoff period. And if the private-label credit card is used for further transactions, the central monitoring service provider and the financial source can share those extra earnings. Thus, instead of the alarm system dealer concealing the purchasing and/or financing costs in the servicing or monitoring contract, the alarm system purchaser pays the purchase and financing cost through the central monitoring service provider. This limits the need for either or both the security alarm dealer and central monitoring service provider to expend time and energy on finding funding for alarm system hardware for potential customers, and prevents potential customers from seeking to use the central monitoring service provider's superior credit score without increasing the recompense for that extra overhead. Additionally, this frees the security alarm dealer and central monitoring service provider from a great burden of associated transaction costs—specifically, any state or local sales tax or Uniform Commercial Code Lien filing fees—which the alarm system hardware vendor otherwise would impose upon the security alarm dealer, central monitoring service provider, or both. For each particular alarm system purchase the security alarm system dealer pays to the central monitoring service provider a one-time financing charge of 27.5% (or $275 for a $1,000 purchase), a 2% non-recourse fee (to cover the risk of purchaser default), and a 2% transaction fee.

In further extensions, the security alarm dealer and central monitoring service provider can not only avoid, but take advantage of for each alarm system purchaser's benefit, cost-cutting, competitive hardware sales efforts which reward higher-volume sales, particular hardware sales, credit quality discounts, or any combination thereof appropriate to each particular alarm system purchaser's credit score.

At the next tier, with the alarm system hardware purchase, the alarm system purchaser enters into several linked but separate contracts with the security alarm dealer. The first of these is an installation contract, for the security alarm dealer to properly install and connect the newly-purchased hardware on the alarm system purchaser's property. The more effective and trained the alarm system dealer's staff are, the more this can become a separate profit source. The second of these is a three-year, monitoring contract with the security alarm dealer which has a monthly monitoring service charge. For the first 36 months this monthly monitoring service charge is $1 per month. This provides continual, regular, and predictable cash flow to the security alarm dealer. The monthly contact through the billing effort also provides a continued channel for suggesting additional profitable subordinate business, a means for providing upgrades (in both hardware and services), and a means to building a brand name for the security alarm dealer. Additionally, the security alarm dealer gets all referrals from his book of satisfied customers and can provide them to potential alarm system purchasers, increasing the efficiency of sales leverage. After the first three-year term, the security alarm dealer offers to the alarm system purchaser a recurring monitoring contract renewal that is priced at or above $19.95 per month. While this represents a dramatic increase in profitability to the alarm system dealer, because the purchase has been paid down, the alarm system purchaser will see a significant drop in his continued service costs. This increases the profitable retention, without tying up the capital of either the alarm system dealer or the central monitoring service by linking it to the alarm system hardware.

In turn, the security alarm dealer has already entered into a six year monitoring contract with the central monitoring service provider, with the first three years prepaid, and a low ($5.50) monthly charge for years four, five, and six. In a further embodiment, additional services above the basic monitoring for an alarm such as telephone or cable line ownership, activity reporting (by event or on schedule), live video monitoring, timer testing, elevator phone monitoring, specific event (e.g. opening or closing) monitoring, interactive monitoring (audio or visual or both), and direct emergency dispatch or patch-through, can be added onto the basic monitoring service, with payment flowing through the alarm system dealer to the central monitoring service provider.

The third linked but separate contract is a maintenance servicing contract, covering any necessary repairs. The alarm system dealer can decide to handle repairs on its own, obtain extended warranty coverage, or sell off the maintenance servicing contract, in whatever manner that alarm system dealer feels best improves its sustained expertise and profitability, whether it decides to either perform the service or subcontract it to a technical firm. The security alarm dealer can either retain this maintenance servicing contract or pass it through to the central monitoring service provider. This allows the security alarm dealer, or the central monitoring service provider, whoever has the volume and extended knowledge of the varieties of a particular customer's alarm systems' hardware, to use its detailed knowledge to arrange for warranty or continuation-of-service insurance contracts at the price and with the entity both most closely reflecting and most technically familiar with the actual behavior of the hardware in practice.

At the final tier, the central monitoring service provider gives each alarm system dealer a set of unique identifiers (IDs). One member of this set is the dealer identifier for that particular alarm system dealer. A subset of members will be employee identifiers for authorized individual employees of that dealer who may make binding commitments with the central monitoring service provider. Another, separate, subset of members will be contract identifiers for alarm system purchasers who have entered into the linked but separate contracts described above. As each recurring monitoring contract is entered into, it is assigned a unique combination of identifiers uniquely denoting the dealer, that particular alarm system purchaser, the hardware, and the associated purchase, monitoring, and servicing contracts. Also the end-date for the monitoring and service contracts are noted and used to plan for pre-termination effort to obtain a renewal, which allows the highest probability of continuation into the longer-term and more profitable years. These identifiers allow continual and real-time monitoring, validity checks, and account tracking for improved efficiency. If a particular alarm system purchaser seeks an upgrade, or requests a particular service (whether a response to a monitored event, a repair, or a renewal), the specific and unique identifier is used to handle such requests, greatly improving the efficiency and thereby increasing the alarm system dealer's cash flow. Each time that purchaser or dealer makes a service request to the central monitoring service provider, the central monitoring service provider verifies that the employee, dealer, and purchaser are authorized to make binding commitments to (and requests of) the central monitoring service provider—and if they are not, solves that problem before acting further, thereby protecting the privacy and other interests of the respective parties.

At the end of any particular monitoring contract, the alarm system purchaser may elect to renew, or end, the contract. If the monitoring contract is renewed, the profit realized by the alarm system dealer increases as stated above. However, if the contract is not renewed, the alarm system purchaser still retains the alarm system hardware which he owns—thereby obviating any need on the part of the alarm system dealer, or the central monitoring service provider, to remove the hardware and then attempt its resale (at a reduced price for used and depreciated equipment). By removing the post-contract obligations of the alarm system dealer and central monitoring service provider, this increases each of their profits, or at least reduces the cost of completed term contracts.

While this invention has been described in reference to illustrative embodiments, this description is not to be construed in a limiting sense. Various modifications and combinations of the illustrative embodiments as well as other embodiments of the invention will be apparent to those skilled in the art upon referencing this disclosure. It is therefore intended this disclosure encompass any such modifications or embodiments.

The scope of this invention includes any combination of the steps from the different embodiments disclosed in this specification, and is not limited to the specifics of the preferred embodiment or any of the alternative embodiments mentioned above. Individual embodiments of this invention may contain all, or less than all, of the steps disclosed in the specification. The claims stated herein should be read as including those steps which are not necessary to the invention yet are in the prior art and are necessary to the overall function of that particular claim, and should be read as including, to the maximum extent permissible by law, known functional equivalents to the steps disclosed in the specification, even though those functional equivalents are not exhaustively detailed herein.

Although the present invention has been described chiefly in terms of the presently preferred embodiment, it is to be understood that the disclosure is not to be interpreted as limiting. Various alterations and modifications will no doubt become apparent to those skilled in the art after having read the above disclosure. The steps herein are not limiting but instructive of the embodiment of the invention, and variations which are readily derived through operations which are standard or known to the appropriate art are not excluded by omission. Accordingly, it is intended that the appended claims are interpreted as covering all alterations and modifications as fall within the true spirit and scope of the invention in light of the prior art.

Additionally, although claims have been formulated in this application to particular combinations of steps, it should be understood that the scope of the disclosure of the present application also includes any single novel step or any novel combination of steps disclosed herein, either explicitly or implicitly, whether or not it relates to the same invention as presently claimed in any claim and whether or not it mitigates any or all of the same technical problems as does the present invention. The applicants hereby give notice that new claims may be formulated to such features and/or combinations of such features during the prosecution of the present application or of any further application derived therefrom.

We claim:

1. A method for providing, through a centralized monitoring service to any combination of monitored security alarm system purchasers and monitored security alarm system dealers, improved efficiency, transparency, and support for financing, selling, monitoring, maintaining, upgrading, renewing, and operating each particular monitored security alarm system, comprising:
making arrangements with a finance provider that enables the centralized monitoring service to check the credit of and offer credit to a monitored security alarm system purchaser who has contacted a monitored security alarm system dealer;
making a credit check by checking, when contacted by the monitored security alarm system dealer, the financial credit of the monitored security alarm system purchaser who has contacted the monitored security alarm system dealer with a request;
reporting the results of the credit check to the monitored security alarm system dealer;
using the results of the credit check to qualify the monitored security alarm system purchaser to buy security alarm system hardware offered by the monitored security alarm system dealer;
providing financial credit to the monitored security alarm purchaser according to the results of the credit check and his qualification to purchase the security alarm system hardware;
recording the purchase and installation by the monitored security alarm system purchaser and the monitored security alarm system dealer, respectively, of the security alarm system hardware;
recording the completion between the monitored security alarm system purchaser and the monitored security alarm system dealer of a monitoring service contract associated with the security alarm system hardware;
contracting with the monitored security alarm system dealer to provide monitoring service for the security alarm system hardware for a set term and a set price, with an option to renew;
reporting to the finance provider the purchase and installation of the security alarm system hardware and the contracts to provide monitoring service;
receiving from the finance provider a transaction fee for the purchase, installation, and contract between the monitored security alarm system dealer and the centralized monitoring service to provide monitoring service for the security alarm system hardware;
subtracting from the transaction fee a set amount for the centralized monitoring service, leaving a remainder;
delivering the remainder to the monitored security alarm system dealer; and,
renewing, upon a subsequent request of the security alarm system purchaser to the monitored security alarm system dealer, the monitoring service contracts.

2. A method as in claim 1, further comprising verifying that the monitored security alarm system dealer is authorized to deal with the centralized monitoring service, before checking the financial credit of the monitored security alarm system purchaser who has contacted the monitored security alarm system dealer with a request.

3. A method as in claim 1, further comprising giving the monitored security alarm system dealer at least one unique identification code to be used to verify that the monitored security alarm system dealer is authorized to deal with the centralized monitoring service in the present and all future transactions between the monitored security alarm system dealer and the centralized monitoring service.

4. A method as in claim 3, further comprising ensuring that each identification code is unique by ensuring each identification code comprises a unique combination of:
a dealer identifier unique to that particular monitored security alarm system dealer;
a set of different and unique employee identifiers including at least one unique employee identifier for each individual, authorized employee of that particular monitored security alarm system dealer; and,
an contract identifier unique to each particular monitoring contract for that particular monitored security alarm system dealer;
thereby enabling precise tracking of all service actions, upgrades, requests, and inquiries.

5. A method as in claim 4, further comprising checking whether a unique identification code is provided by the monitored security alarm system dealer that validates his authorization.

6. A method as in claim 1, wherein the step of providing financial credit to the monitored security alarm purchaser according to the results of the credit check and his qualification to purchase the particular security alarm system hardware, further comprises offering the monitored security alarm purchaser a credit card issued by the finance provider through the centralized monitoring service, which credit card may be used to purchase the security alarm system hardware immediately on issuance, and for other purchases thereafter.

7. A method as in claim 6, further comprising, after the step of using the results of the credit check to qualify the monitored security alarm system purchaser to buy security alarm system hardware offered by the monitored security alarm system dealer:
changing, based on the results of the credit check, the purchase price for the security alarm system hardware to more accurately reflect the relative quality of the monitored security alarm system purchaser's credit over the norm of most monitored security alarm system purchasers.

8. A method as in claim 7, further comprising decreasing the purchase price to reflect an improved quality of the monitored security alarm system purchaser's credit over the norm of most monitored security alarm system purchasers.

9. A method as in claim 7, further comprising increasing the purchase price to reflect a decreased quality of the monitored security alarm system purchaser's credit over the norm of most monitored security alarm system purchasers.

10. A method as in claim 6, further comprising, after the step of using the results of the credit check to qualify the monitored security alarm system purchaser to buy security alarm system hardware offered by the monitored security alarm system dealer:
changing the purchase price for the security alarm system hardware to more accurately reflect the effect of the monitored security alarm system dealer's dealings having a notably different volume of business with the centralized monitoring service over the norm of most monitored security alarm system dealers.

11. A method as in claim 10, further comprising increasing the purchase price for the security alarm system hardware to more accurately reflect the monitored security alarm system dealer's having a notably lesser volume of business with the centralized monitoring service over the norm of most monitored security alarm system dealers.

12. A method as in claim 10, further comprising decreasing the purchase price for the security alarm system hardware to more accurately reflect the monitored security alarm system dealer's having a notably greater volume of business with the centralized monitoring service over the norm of most monitored security alarm system dealers.

13. A method as in claim 6, further comprising, after the step of using the results of the credit check to qualify the monitored security alarm system purchaser to buy security alarm system hardware offered by the monitored security alarm system dealer:
changing the purchase price for the security alarm system hardware to more accurately reflect the effect of a notably different sales volume for the security alarm system hardware over the norm for most security alarm system hardware.

14. A method as in claim 13, further comprising increasing the purchase price for the security alarm system hardware to more accurately reflect the security alarm system hardware having a notably lesser volume of business with the centralized monitoring service over the norm for most security alarm system hardware

15. A method as in claim 13, further comprising decreasing the purchase price for the security alarm system hardware to more accurately reflect the security alarm system hardware having a notably greater volume of business with the centralized monitoring service over the norm for most security alarm system hardware.

16. A method as in claim 13, further comprising decreasing the purchase price for the security alarm system hardware to more accurately reflect the security alarm system hardware being offered on temporarily more advantageous terms by its vendor.

17. A method as in claim 6, further comprising, after the step of using the results of the credit check to qualify the monitored security alarm system purchaser to buy security alarm system hardware offered by the monitored security alarm system dealer:
changing the purchase price for the security alarm system hardware to be offered by the monitored security alarm system dealer, to more accurately reflect any combination of the relative quality of the monitored security alarm system purchaser's credit over the norm of most monitored security alarm system purchasers, a notably different volume of business with the centralized monitoring service over the norm of most monitored security alarm system dealers, a notably different sales volume for the security alarm system hardware over the norm for most security alarm system hardware, the security alarm system hardware being offered on temporarily more advantageous terms by its vendor, a notably different sales volume for that particular security alarm system hardware, and a temporary sales price difference for that particular security alarm system hardware.

18. A method as in claim 1, wherein the step of subtracting from the transaction fee a set amount for the centralized monitoring service, leaving a remainder, further comprises:
subtracting a set fee for the first three-year monitoring contract term;
subtracting a one-time financing charge;
subtracting a non-recourse fee to cover the risk of default by the monitored security alarm system purchaser; and,
subtracting a transaction fee.

19. A method as in claim 18, wherein the step of subtracting from the transaction fee a set amount for the centralized monitoring service, leaving a remainder, further comprises:
subtracting $36 for the set fee for the first three-year monitoring contract term;
subtracting no more than 27.5% for the one-time financing charge;
subtracting no more than 2% for the non-recourse fee to cover the risk of default by the monitored security alarm system purchaser; and,
subtracting no more than 2% for the transaction fee of.

20. A method as in claim 1, further comprising adding, at the request of the monitored security alarm system purchaser, additional services above the basic monitoring with payment flowing through the alarm system dealer to the central monitoring service provider.
